(19) United States
(12) Patent Application Publication
(10) Pub. No.: US 2012/0256737 A1
(43) Pub. Date: Oct. 11, 2012

(54) PORTABLE TERMINAL WITH REMOTE CONTROL FUNCTION AND METHOD OF PERFORMING REMOTE CONTROL USING THE SAME

(75) Inventor: Jeong Hyun PARK, Daejeon (KR)

(73) Assignee: Electronics and Telecommunications Research Institute, Daejeon (KR)

(21) Appl. No.: 13/443,403

(22) Filed: Apr. 10, 2012

(30) Foreign Application Priority Data
Apr. 11, 2011 (KR) 10-2011-0033292

(51) Int. Cl. G05B 11/01

(52) U.S. Cl. 340/12.54

(57) ABSTRACT

Provided is a portable terminal with a remote control function for improving control convenience when a user controls a control target apparatus. The portable terminal with the remote control function includes a storing part for storing control information, an input/output part for displaying the control information and providing a control event signal, a controller for reading the control information from the storing part, and a remote-control transmitting part for generating a remote control signal to transmit the generated remote control signal to a control target apparatus.

### CLAIM FOR PRIORITY

This application claims priority to Korean Patent Application No. 10-2011-0033292 filed on Apr. 11, 2011 in the Korean Intellectual Property Office (KIPO), the entire contents of which are hereby incorporated by reference.

### BACKGROUND

1. Technical Field

Example embodiments of the present invention relate in general to remote control of a control target apparatus and more specifically to a portable terminal with a remote control function and a method of performing remote control using the same.

2. Related Art

Households and offices have exclusive remote controls for separate apparatuses, such as a remote control for a television, a remote control for a DVD, a remote control for an audio, etc. Thus, management of the exclusive remote controls for the separate apparatuses and familiarization with methods of using them in the household or the office may be inconvenient. Also, because the exclusive remote controls use separate dry cells, when one dry cell is exhausted, it should be exchanged with a new dry cell separately. This can causes economic waste due to periodical replacement of the dry cells and an environmental problem due to the number of dry cells discarded with the lapse of time.

Further, a karaoke room, in which many people spend their spare time, has two or three exclusive remote controls used by people to select songs. When a song is to be selected in the karaoke room, there is an inconvenience of asking the person closest to the exclusive remote control to pass the exclusive remote controls, or of informing the person of the numbers of the song one wishes to sing.

### SUMMARY

Accordingly, example embodiments of the present invention are provided to substantially obviate one or more problems due to limitations and disadvantages of the related art.

Example embodiments of the present invention provide a portable terminal with a remote control function, which is suitable for improving control convenience when a separately control target apparatus is controlled by a user.

Example embodiments of the present invention also provide a method of performing remote control using a portable terminal with a remote control function, which is capable of improving control convenience when a separately control target apparatus is controlled by a user.

Example embodiments of the present invention provide a portable terminal with a remote control function comprising a storing part configured to store control information corresponding to at least one control target apparatus, an input/output part configured to display the control information of the at least one control target apparatus and provide control event signal corresponding to a control operation of a user, a controller configured to read control information corresponding to information of the at least one control target apparatus from the storing part when the control information is in the storing part, and to provide the read control information to the input/output part and control so as to generate a remote control signal corresponding to the control event signal provided from the input/output part, and a remote-control transmitting part configured to generate the remote control signal corresponding to the control of the controller to transmit the generated remote control signal to the at least one control target apparatus. The portable terminal may further comprise at least one of a camera, a bar code reader, an image code reader and an RFID reader, and a control-target-apparatus information acquiring part configured to acquire the information of the at least one control target apparatus using the at least one of the camera, the bar code reader, the image code reader and the RFID reader and provide the acquired information of the at least one control target apparatus to the controller. The portable terminal may further comprise a network interface part configured to receive the control information over the Internet through at least one of wired communication and wireless communication corresponding to the control of the controller to provide the received control information to the controller. When the control information corresponding to the at least one control target apparatus is not in the storing part, the controller may download the control information through the network interface part to provide the downloaded control information to the input/output part and control so as to generate the remote control signal corresponding to the control event signal provided from the input/output part.

Other example embodiments of the present invention provide a method of performing remote control using a portable terminal with a remote control function, the method comprising determining whether control information corresponding to a control target apparatus is stored, reading a control menu from the control information when the control information corresponding to the control target apparatus is stored, to display the read control menu, generating a remote control signal for controlling the control target apparatus corresponding to an operation of the control menu from a user, and transmitting the generated remote control signal to the control target apparatus. The method may further comprise acquiring information on the control target apparatus using at least one of a camera, a bar code reader, an image code reader and an RFID reader. The process of determining whether the control information corresponding to the control target apparatus is stored may comprise connecting to the Internet through at least one of wired communication and wireless communication when the control information corresponding to the control target apparatus is not stored, determining whether the control information is capable of being downloaded from the Internet, and downloading the control information from the Internet to store the downloaded control information when the control information is capable of being downloaded from the Internet.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram showing a user environment of a portable terminal with a remote control function according to example embodiments of the present invention.

FIG. 2 is a block diagram showing a structure of a portable terminal with a remote control function according to example embodiments of the present invention.

FIG. 3 is a user interface screen showing a control menu of a remote control for a TV, which is displayed in a portable terminal with a remote control function according to example embodiments of the present invention.

FIG. 4 is a user interface screen showing a control menu of a remote control for a karaoke machine, which is displayed in a portable terminal with a remote control function according to example embodiments of the present invention.

FIG. 5 is a flow chart illustrating a method of performing remote control using a portable terminal with a remote control function according to example embodiments of the present invention.

FIG. 6 is a detailed example of a method of remotely controlling a TV in a method of performing remote control using a portable terminal with a remote control function according to example embodiments of the present invention.

FIG. 7 is a detailed example of a method of remotely controlling a karaoke machine in a method of performing remote control using a portable terminal with a remote control function according to example embodiments of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention should not be construed as limited to example embodiments of the present invention set forth herein but may be embodied in many alternate forms.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

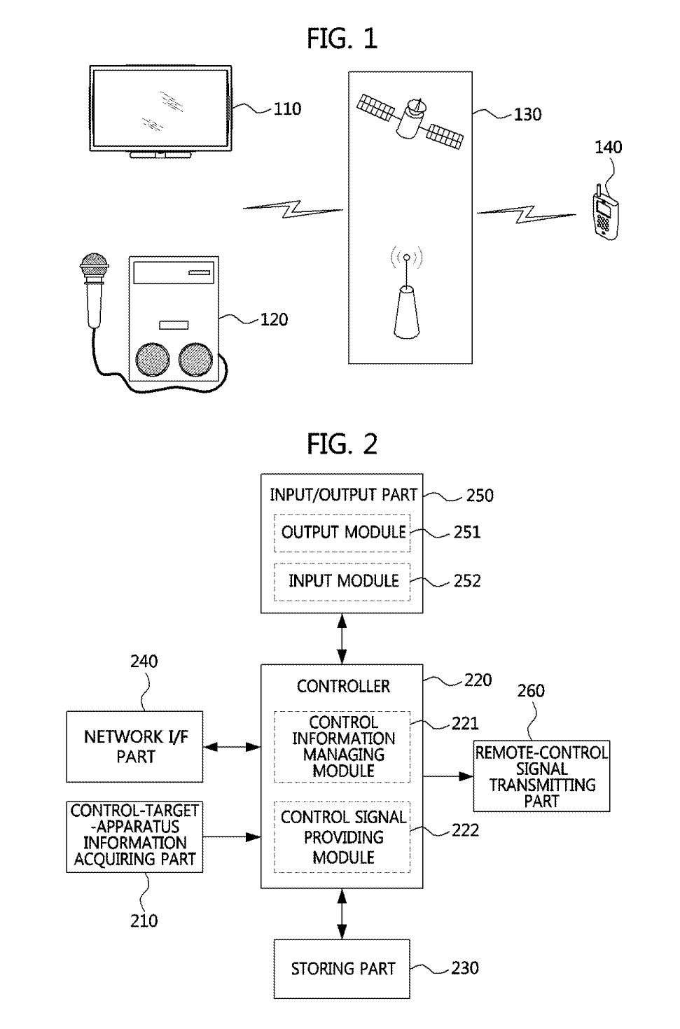

FIG. 1 is a conceptual diagram showing a user environment of a portable terminal with a remote control function according to example embodiments of the present invention.

Referring to FIG. 1, a user environment of a portable terminal with a remote control function according to example embodiments of the present invention may be composed of a TV/Internet TV 110, a karaoke machine 120, communication environment 130 and a portable terminal 140. The portable terminal 140 may remotely control the TV/Internet TV 110 and the karaoke machine 120. Also, when there is no control information by which remote control is possible, the portable terminal 140 may remotely control the TV/Internet TV 110 and the karaoke machine 120 by downloading control information through the communication environment 130.

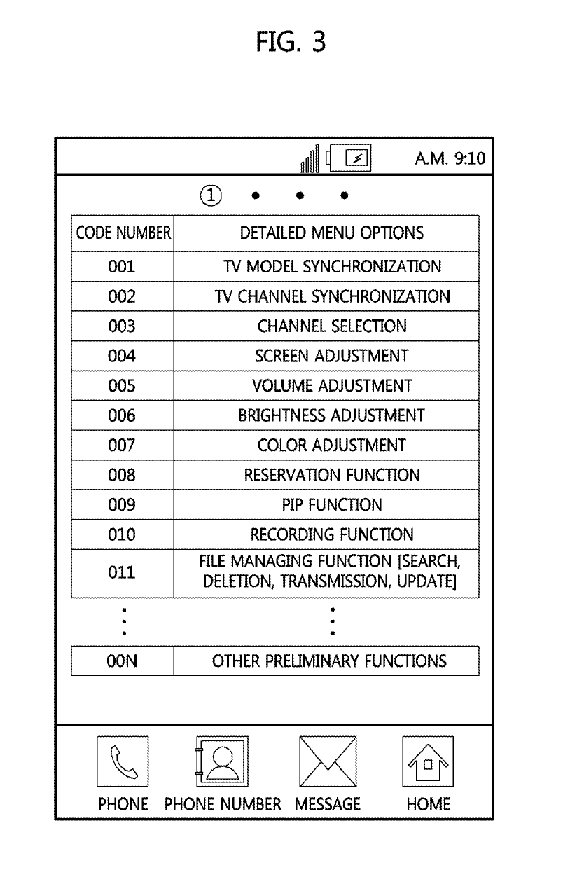

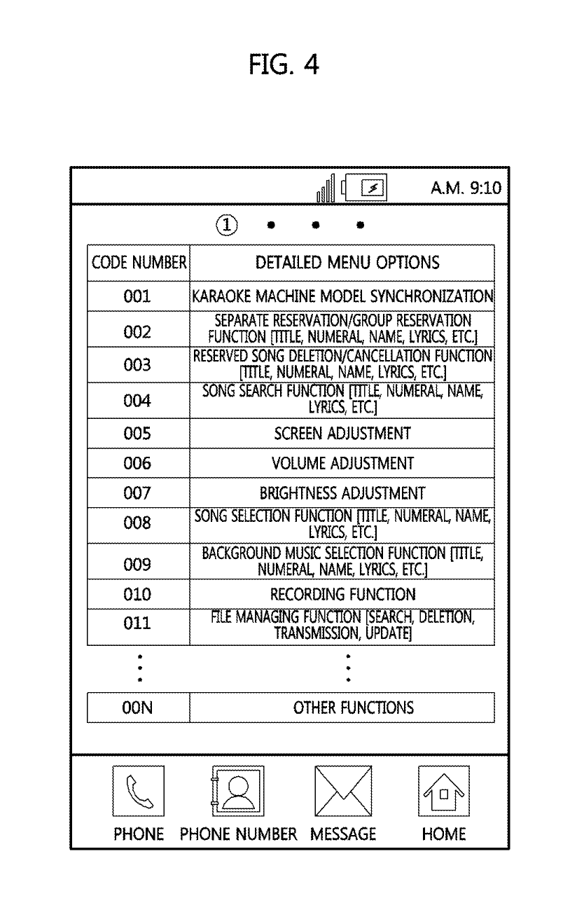

FIG. 2 is a block diagram showing a structure of a portable terminal with a remote control function according to example embodiments of the present invention. FIGS. 3 and 4 are user interface screens showing control menus of remote controls for a TV and a karaoke machine, which are displayed in a portable terminal with a remote control function according to example embodiments of the present invention.

Referring to FIG. 2, the portable terminal with the remote control function according to example embodiments of the present invention may include a control-target-apparatus information acquiring part 210, a controller 220, a storing part 230, a network I/F part 240, an input/output part 250, and a remote-control signal transmitting part 260. Illustration of well known structures for performing functions of the portable terminal that are not directly related to example embodiments of the present invention will be omitted. Also, the portable terminal is assumed to be switched to a remote control mode.

The control-target-apparatus information acquiring part 210 may include at least one of a camera module 211, a bar code/image code reader module 212, and an RFID reader module 213. The control-target-apparatus information acquiring part 210 may acquire information on a control target apparatus from the control target apparatus. Here, the control target apparatus may be, for example, a TV, a karaoke machine, an audio device, an air conditioner, a heater, a computer, a projector, an electric refrigerator, an electric fan, a humidifier, a copier, etc. The acquired information on the control target apparatus may be, for example, a manufacturing company, a product name, a manufacture's serial number, a uniform resource locator (URL), etc., which are related to the control target apparatus.

The camera module 211 may use a camera (not shown) to photograph the control target apparatus and to provide an image of the control target apparatus to the controller 220.

When the control target apparatus is labeled with a bar code or an image code, the bar code/image code reader module 212 may use the camera to read the bar code or the image code from the control target apparatus and to provide the read bar code or image code to the controller 220.

When an RFID tag is attached to the control target apparatus, the RFID reader module 213 may use an RFID reader to acquire the RFID tag and to provide the acquired RFID tag to the controller 220.

However, the above method of acquiring the information of the control target apparatus is only exemplary and is not limited thereto.

The controller 220 may extract the information of the control target apparatus from the photographed image of the control target apparatus, the read bar code or image code, or the acquired RFID tag and may determine whether control information corresponding to the extracted information of the control target apparatus is or is not in the storing part 230.

When the control information corresponding to the extracted information of the control target apparatus is determined not to be in the storing part 230, the controller 220 may download the control information through the network I/F part 240 using the extracted information of the control target apparatus. The controller 220 may store the downloaded control information in the storing part 230, output the stored control information to the input/output part 250, generate a control signal according to an operational signal from a user, and provide the generated control signal to the remote-control signal transmitting part 260.

On the other hand, when the control information corresponding to the extracted information of the control target apparatus is determined to be in the storing part 230, the controller 220 may provide the control information to the input/output part 250, generate a control signal according to an operational signal acquired from the input/output part 250, and provide the generated control signal to the remote-control signal transmitting part 260.

In further detail, the controller 220 may composed of a control information managing module 221 and a control information providing module 222.

The control information managing module 221 may extract the information on the control target apparatus from the photographed image of the control target apparatus, the read bar code or image code, or the acquired RFID tag which are acquired by the control-target-apparatus information acquiring part 210 and may search the storing part 230 for the control information corresponding to the extracted information of the control target apparatus.

When the control information corresponding to the extracted information of the control target apparatus is not found in the storing part 230, the control information managing module 221 may download control information corresponding to the extracted information (for example, the manufacturing company, the product name, the manufacture's serial number, the URL, etc.) of the control target apparatus through the network I/F part 240.

Next, the control information managing module 221 may provide the downloaded control information to the input/output part 250 and may store the downloaded control information in the storing part 230. However, when the control information is not able to be downloaded through the network I/F part 240, the control information managing module 221 generate a message ‘Cannot be remotely controlled’ and provide the message to the input/output part 250.

When the control information corresponding to the extracted information of the control target apparatus is found in the storing part 230, the control information managing module 221 may read the control information from the storing part 230 to provide the read control information to the input/output part 250.

Here, the control information is different for each control target apparatus, and the manufacturing company provides the control information for each control target apparatus.

Also, when the control information managing module 221 receives a request to provide data/a file from the input/output part 250, the control information managing module 221 may provide information related to the data/file to the network I/F part 240 to download the data/file through the network I/F part 240.

Next, the control information managing module 221 may provide the downloaded data/file to the input/output part 250 and store the downloaded data/file in the storing part 230.

Here, the downloaded data/file may include, for example, music, lyrics, a song, an MP3, a video, a photograph, etc.

The control signal providing module 222 may acquire an operational signal from the input/output part 250 to provide a control signal for generating a remote control signal corresponding to the acquired operational signal to the remote-control signal transmitting part 260.

FIG. 3 is a user interface screen showing a control menu of a remote control for a TV, which is displayed in a portable terminal with a remote control function according to example embodiments of the present invention.

Referring to FIG. 3, in the portable terminal with the remote control function on the control target apparatus according to example embodiments of the present invention, a control menu of a remote control for a TV displayed in the portable terminal may include TV model synchronization 001, TV channel synchronization 002, channel selection 003, screen adjustment 004, volume adjustment 005, brightness adjustment 006, color adjustment 007, a reserving function 008, a picture-in-picture (PIP) function 009, a recording function 010, file managing function 011, other preliminary functions 00N, etc.

Here, the file managing function 011 may include file search, file deletion, file transmission, and file update functions.

Referring again to FIG. 2, the control signal providing module 222 may acquire operational signals directly selecting each of the above elements in the control menu of the remote control for the TV from the input/output part 250 or may acquire operational signals inputting codes corresponding to each of the elements in the control menu of the remote control for the TV from the input/output part 250, and provide the control signal for generating the remote control signal corresponding to the acquired operational signal to the remote-control signal transmitting part 260.

Also, FIG. 4 is a user interface screen showing a control menu of a remote control for a karaoke machine, which is displayed in a portable terminal with a remote control function according to example embodiments of the present invention.

Referring to FIG. 4, in the portable terminal with the remote control function on the control target apparatus according to example embodiments of the present invention, a control menu of a remote control for a karaoke machine displayed in the portable terminal may include karaoke machine model synchronization 001, a separate reservation/group reservation function 002, a reserved song deletion/cancellation function 003, a song retrieval function 004, screen adjustment 005, volume adjustment 006, brightness adjustment 007, color adjustment 008, a song selection function 009, a background music selection function 010, a recording function 011, file managing function 012, other functions 00N, etc.

Here, for the separate reservation/group reservation function 002, the reserved song deletion/cancellation function 003, the song retrieval function 004, the song selection function 009, and the background music selection function 010, a song title, a numeral corresponding to the song, a name of a singer, lyrics, etc. may be used. Also, the file managing function 012 may include file search, file deletion, file transmission, and file update functions.

Referring again to FIG. 2, the control signal providing module 222 may acquire operational signals directly selecting each of the above elements in the control menu of the remote control for the karaoke machine or may acquire operational signals inputting codes corresponding to each of the elements in the control menu of the remote control for the karaoke machine from the input/output part 250, and provide the control signal for generating the remote control signal corresponding to the acquired operational signal to the remote-control signal transmitting part 260.

The controller 230 may store control information, for example, a control program, a file, etc. Also, the controller 230 may acquire control information provided from the controller 220 and may additionally store the acquired control information, separately from previously stored control information.

The network I/F part 240 may be composed of a wireless communication module and/or a wired communication module. The network I/F part 240 may acquire control information from the controller 220, receive control information through wireless communication and/or wired communication from an external network, and provide the received control information to the controller 220.

The input/output part 250 may acquire control information from the controller 220 to display the acquired control information, acquire an operational signal corresponding to an operation of the user, and provide the acquired operational signal to the controller 220.

In further detail, the input/output part 250 may include an output module 251 and an input module 252.

The output module 251 may acquire control information from the controller 220 to display the acquired control information. Also, the output module 251 may display a message ‘Cannot be remotely controlled’ acquired from the controller 220.

Here, the output module 251 may be composed of a liquid crystal display (LCD) or an organic light-emitting diode (OLED). However, the above composition of the output module 251 is only exemplary and is not limited thereto.

The input module 252 may be composed of a plurality of keys for inputting numerals or letters, or for performing specific functions, and may acquiring an operational signal corresponding to an operation of the user, and provide the acquired operational signal to the controller 220. However, the above composition of the input module 252 is only exemplary and is not limited thereto.

The remote-control signal transmitting part 260 may acquire control information from the controller 220, generate a remote control signal corresponding to the acquired control information, and transmit the generated remote control signal to the control target apparatus.

Through the above transmission of the remote control signal from the remote-control signal transmitting part 260, data or a file may be transmitted to the control target apparatus, or control of the channel selection, the screen adjustment, the volume adjustment, the brightness adjustment, the color adjustment, the reservation function, the PIP function, the recording function, etc., may be performed with respect to the control target apparatus.

In further detail, after the remote-control signal transmitting part 260 generates the remote control signal corresponding to the acquired control information from the controller 220, the transmission of the generated remote control signal to the control target apparatus may be performed using radio frequency (RF), infrared rays (IR), Bluetooth, etc.

Firstly, in the transmission of the generated remote control signal using the RF, RF processing is performed on the control signal acquired from the controller 220 and the processed RF is transmitted to the control target apparatus.

In the transmission of the generated remote control signal using the IR, the remote-control signal transmitting part 260 oscillates the remote control signal acquired from the controller 220 as a pulse signal corresponding to a frequency of the control target apparatus, and the oscillated pulse signal is modulated as an IR signal for wireless transmission to transmit the modulated infrared ray signal.

In the transmission of the generated remote control signal using Bluetooth, the remote-control signal transmitting part 260 transmits data or a file from the portable terminal to the control target apparatus when the control signal acquired from the controller 220 is, for example, a data- or file-transmitting signal.

Here, the above used methods of transmitting the control signal are only exemplary and are not limited thereto.

In the portable terminal with the remote control function on the control target apparatus according to example embodiments of the present invention, although the block diagram showing the structure of the portable terminal in FIG. 2 illustrates a case in which the control information, for example, a control program, a file, etc., is not fully stored in the storing unit 230, a portable terminal with a remote control function on a control target apparatus according to other example embodiments of the present invention may be composed of the controller 220, the storing part 230, the input/output part 250 and the remote-control signal transmitting part 260.

Thus, if the controller 220 acquires a plurality of control information stored in the storing part 230 to provide the acquired control information to the input/output part 250, the input/output part 250 may display the acquired control information and provide an operational signal of the user to the controller 220.

Next, the controller 220 may provide a control signal for generating a remote control signal corresponding to the operational signal to the remote-control signal transmitting part 260, which may generate the remote control signal corresponding to the control signal to transmit the generated remote control signal to the control target apparatus.

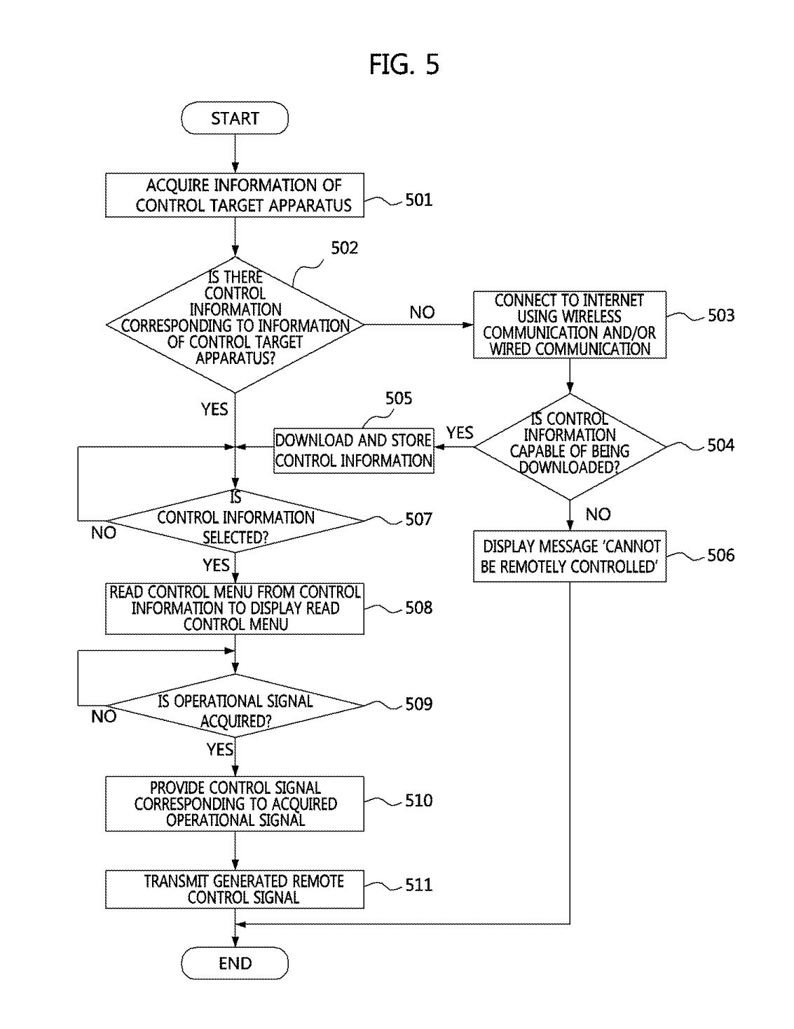

FIG. 5 is a flow chart illustrating a method of performing remote control using a portable terminal with a remote control function according to example embodiments of the present invention.

In the method of performing remote control using the portable terminal with the remote control function (hereinafter referred to as ‘the portable terminal’) as shown in FIG. 5, the portable terminal is assumed to be switched to a remote control mode.

Referring to FIG. 5, the portable terminal may firstly acquire information on the control target apparatus from the control target apparatus in step 501, and determine whether there is control information corresponding to the information on the control target apparatus in step 502.

Here, the control target apparatus may be, for example, a TV, a karaoke machine, an audio device, an air conditioner, a heater, a computer, a projector, an electric refrigerator, an electric fan, a humidifier, a copier, etc. The acquired information on the control target apparatus may be a manufacturing company of the control target apparatus, a product name, a manufacture's serial number, a URL, etc.

A method of acquiring the information on the control target apparatus may be a method of photographing the control target apparatus using a camera to acquire image of the control target apparatus when the portable terminal has the camera, a method of acquiring a bar code or image code from the control target apparatus using a camera when the bar code or the image code is displayed in the control target apparatus, and a method of acquiring an RFID tag through an RFID reader when the control target apparatus has the RFID tag, etc.

However, the above method of acquiring the information on the control target apparatus is only exemplary and is not limited thereto.

When it is determined that there is no control information corresponding to the information of the control target apparatus in step 502, the portable terminal may connect to the Internet using wireless communication and/or wired communication in step 503, and may determine whether control information corresponding to the information (for example, the manufacturing company, the product name, the manufacture's serial number, the URL, etc.) on the control target apparatus is capable of being downloaded in step 504.

When it is determined that the control information is capable of being downloaded in step 504, the portable terminal may download the control information to display the downloaded control information for the user's confirmation and store the downloaded control information in step 505.

However, when it is determined that the control information is incapable of being downloaded in step 504, the portable terminal may generate a message ‘Cannot be remotely controlled’ and may display the generated message ‘Cannot be remotely controlled’ in step 506.

When it is determined that there is control information corresponding to the information of the control target apparatus in step 502 or that the control information is capable of being downloaded in step 505, the portable terminal may determine whether an operational signal selecting the control information is acquired from the user in step 507.

When it is determined that the operational signal selecting the control information is acquired from the user in step 507, the portable terminal may read a control menu from the control information to display the read control menu for the user's confirmation in step 508.

Next, the portable terminal may determine whether an operational signal selecting the control menu is acquired from the user in step 509. The portable terminal may include a plurality of keys for inputting numerals or letters or for performing specific functions.

Here, the operational signal selecting the control menu may be acquired, for example, by directly selecting control menus of remote controls for the TV/the karaoke machine from the user and by inputting codes corresponding to each of the control menus of the remote controls for the TV/the karaoke machine.

When the operational signal is acquired in step 509, the portable terminal may provide a control signal for generating a remote control signal corresponding to the acquired operational signal in step 510.

The portable terminal may acquire the control signal in step 510, and may generate the remote control signal corresponding to the acquired control signal to provide the generated remote control signal to the control target apparatus in step 511.

Trough the above transmission of the control signal, data or a file may be transmitted to the control target apparatus, or performance of channel selection, screen adjustment, volume adjustment, brightness adjustment, color adjustment, a reservation function, a PIP function, a recording function, etc. may be controlled with respect to the control target apparatus.

Here, the above transmission of the control signal may be performed using RF, IR, Bluetooth, etc.

In further detail, in the transmission of the control signal using the RF, RF processing is performed on the control signal acquired from the portable terminal and the processed RF is transmitted to the control target apparatus.

In the transmission of the control signal using the IR, the control signal acquired from the portable terminal is oscillated as a pulse signal corresponding to a frequency of the control target apparatus, and the oscillated pulse signal is modulated as an IR signal for wireless transmission to transmit the modulated IR signal.

In the transmission of the control signal using Bluetooth, data or a file is transmitted from the portable terminal to the control target apparatus when the control signal acquired from the portable terminal is, for example, a data- or file-transmitting signal.

However, the above used methods of transmitting the control signal are only exemplary and are not limited thereto.

The flow chart of FIG. 5 illustrating the method of performing remote control using the portable terminal with the remote control function according to example embodiments of the present invention shows, as a example, the case in which the control information is not fully stored in the portable terminal. However, in other example embodiments of the present invention, a method of performing remote control using a portable terminal with a remote control function may include determining whether there is control information corresponding to information of the control target apparatus, reading a control menu from the control information when there is control information corresponding to the information of the control target apparatus exist, generating a remote control signal for controlling the corresponding control target apparatus according to an operation of the control menu from the user, and transmitting the generated remote control signal to the control target apparatus.

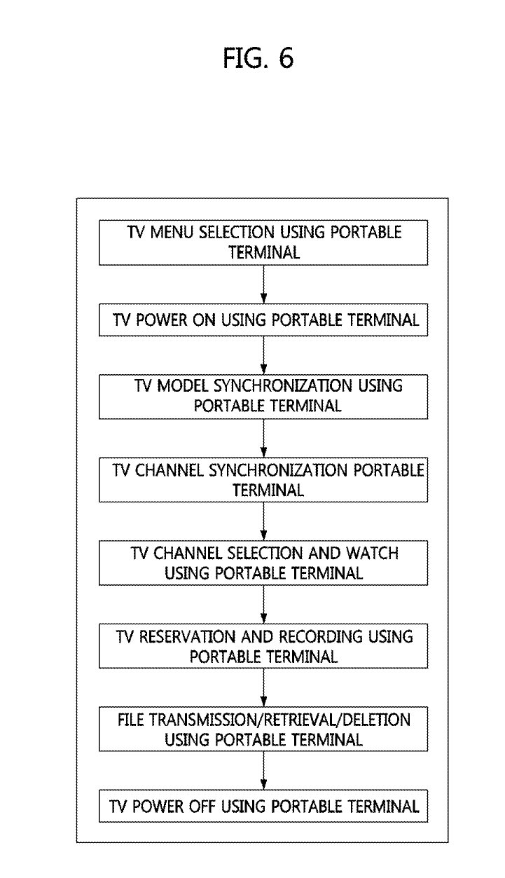

FIG. 6 is a detailed example of a method of remotely controlling a TV in a method of performing remote control using a portable terminal with a remote control function according to example embodiments of the present invention.

Referring to FIG. 6, when an operational signal selecting a control menu for a TV is acquired from a user, a portable terminal may output a structure of the control menu for the TV, and when an operational signal for turning the TV on is acquired from the user, and the portable terminal may transmit a control signal to the TV to turn the TV on.

After the TV is turned on, when the operational signal is acquired from the user, the portable terminal may perform TV model synchronization, TV channel synchronization, TV channel selection and watch, TV reservation and recording, file transmission, file search, file deletion, TV power off, etc., according to the acquired operational signal.

Here, the portable terminal may also acquire an operational signal directly selecting the control menu of the remote control for the TV, or may also acquire operational signals inputting codes corresponding to each of elements of the control menu of the remote control for the TV.

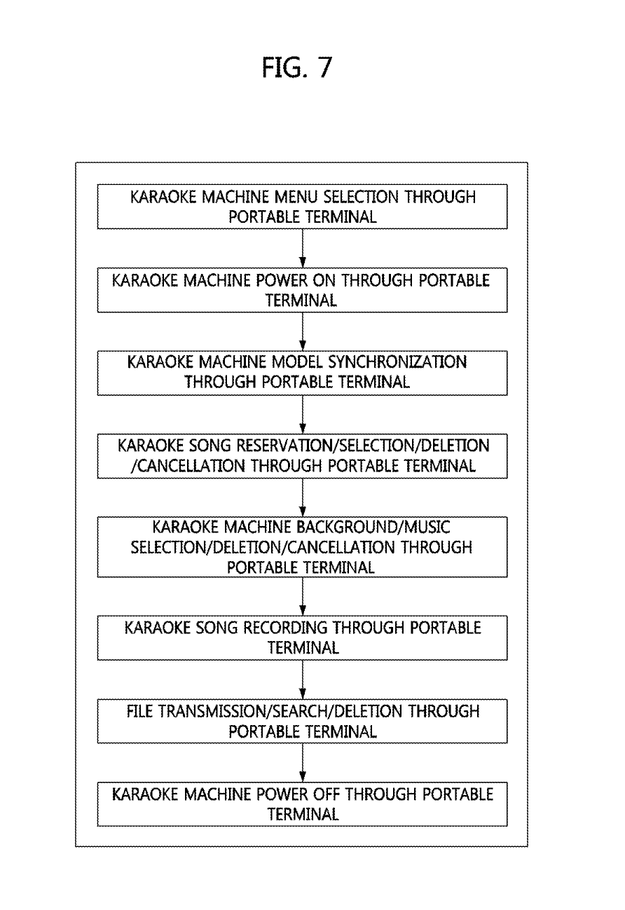

FIG. 7 is a detailed example of a method of remotely controlling a karaoke machine in a method of performing remote control using a portable terminal with a remote control function according to example embodiments of the present invention.

Referring to FIG. 7, when an operational signal selecting a control menu for a karaoke machine is acquired from a user, a portable terminal may output a structure of the control menu for the karaoke machine, and when an operational signal for turning the karaoke machine on is acquired from the user, the portable terminal may transmit a control signal to the karaoke machine to turn the karaoke machine on.

After the karaoke machine is turned on, when the operational signal is acquired from the user, the portable terminal may perform karaoke machine model synchronization, karaoke song reservation, song selection, song deletion, song cancellation, karaoke machine background screen selection, background music selection, background music deletion, background music cancellation, song recording, file transmission, file search, file deletion, karaoke machine power off, etc., according to the acquired operational signal.

Here, the portable terminal may also acquire an operational signal directly selecting the control menu of the remote control for the karaoke machine, or may also acquire operational signals inputting codes corresponding to each of elements of the control menu of the remote control for the karaoke machine.

As described above, in a portable terminal with a remote control function and the method of performing remote control using the same according to example embodiments of the present invention, the portable terminal may include a controller configured to provide control information for determining whether there is a control program corresponding to information on a control target apparatus and generate a control signal corresponding to a acquired operational signal to provide the generated control signal, an input/output part configured to display the control information acquired from the controller and provide the acquired control signal to the controller, and a remote-control signal transmitting part configured to transmit the acquired control signal. Thus, the portable terminal may improve convenience when the user controls the control target apparatus.

While the example embodiments of the present invention and their advantages have been described in detail, it should be understood that various changes, substitutions and alterations may be made herein without departing from the scope of the invention.

What is claimed is:

1. A portable terminal with a remote control function comprising:
a storing part configured to store control information corresponding to at least one control target apparatus;
an input/output part configured to display the control information of the at least one control target apparatus and provide control event signal corresponding to a control operation of a user;
a controller configured to read control information corresponding to information of the at least one control target apparatus from the storing part when the control information is in the storing part, and to provide the read control information to the input/output part and control so as to generate a remote control signal corresponding to the control event signal provided from the input/output part; and
a remote-control transmitting part configured to generate the remote control signal corresponding to the control of the controller to transmit the generated remote control signal to the at least one control target apparatus.

2. The portable terminal of claim 1, further comprising at least one of a camera, a bar code reader, an image code reader and an RFID reader, and a control-target-apparatus information acquiring part configured to acquire the information of the at least one control target apparatus using the at least one of the camera, the bar code reader, the image code reader and the RFID reader and provide the acquired information of the at least one control target apparatus to the controller.

3. The portable terminal of claim 1, further comprising a network interface part configured to receive the control information over the Internet through at least one of wired communication and wireless communication corresponding to the control of the controller to provide the received control information to the controller.

4. The portable terminal of claim 3, wherein, when the control information corresponding to the at least one control target apparatus is not in the storing part, the controller downloads the control information through the network interface part to provide the downloaded control information to the input/output part and control so as to generate the remote control signal corresponding to the control event signal provided from the input/output part.

5. A method of performing remote control using a portable terminal with a remote control function, the method comprising:
determining whether control information corresponding to a control target apparatus is stored;
reading a control menu from the control information when the control information corresponding to the control target apparatus is stored, to display the read control menu;
generating a remote control signal for controlling the control target apparatus corresponding to an operation of the control menu from a user; and
transmitting the generated remote control signal to the control target apparatus.

6. The method of claim 5, further comprising acquiring information on the control target apparatus using at least one of a camera, a bar code reader, an image code reader and an RFID reader.

7. The method of claim 5, wherein determining whether the control information corresponding to the control target apparatus is stored comprises:
connecting to the Internet through at least one of wired communication and wireless communication when the control information corresponding to the control target apparatus is not stored;
determining whether the control information is capable of being downloaded from the Internet; and
downloading the control information from the Internet to store the downloaded control information when the control information is capable of being downloaded from the Internet.
